(19) United States
(12) Patent Application Publication
(10) Pub. No.: US 2022/0100783 A1
(43) Pub. Date: Mar. 31, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Kengo TOKUCHI, Kanagawa (JP)

(73) Assignee: FUJIFILM Business Innovation Corp., Tokyo (JP)

(21) Appl. No.: 17/322,639

(22) Filed: May 17, 2021

(30) Foreign Application Priority Data
Sep. 30, 2020 (JP) 2020-166323

(51) Int. Cl. G06F 16/332; G06K 9/62; G06N 20/00; G06F 40/35

(52) U.S. Cl. CPC G06F 16/3329; G06K 9/6256; G06F 16/3326; G06K 9/6262; G06F 40/35; G06N 20/00

(57) ABSTRACT

An information processing apparatus includes a processor configured to output a plurality of answers to a question item by using an artificial intelligence, the processor being configured to: output a first answer of the plurality of answers to the question item; and output, in a case where a predetermined condition is satisfied after the first answer is output, a first notification regarding a second answer of the plurality of answers to the question item, the second answer being a new answer to the question item under the predetermined condition.

### CROSS-REFERENCE TO RELATED APPLICATIONS

This application is based on and claims priority under 35 USC 119 from Japanese Patent Application No. 2020-166323 filed Sep. 30, 2020.

### BACKGROUND

### (i) Technical Field

The present disclosure relates to an information processing apparatus and a non-transitory computer readable medium.

### (ii) Related Art

A technique for properly identifying an artificial intelligence and properly understanding what the artificial intelligence that is to be run is like is described in Japanese Patent No. 6660030.

### SUMMARY

In the case where an answer to a question item is output using an artificial intelligence, for example, when learning data is added or a learning model is changed, a new answer different from a previously output answer may be output. However, in the case where an answer to a question is obtained from the artificial intelligence and a new answer to the question is then generated, it is difficult for a user to understand that the new answer has been generated.

Aspects of non-limiting embodiments of the present disclosure relate to allowing, in a case where an answer to a question is obtained from an artificial intelligence and a new answer to the question is then generated, a user to understand that the new answer has been generated.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to output a plurality of answers to a question item by using an artificial intelligence, the processor being configured to: output a first answer of the plurality of answers to the question item; and output, in a case where a predetermined condition is satisfied after the first answer is output, a first notification regarding a second answer of the plurality of answers to the question item, the second answer being a new answer to the question item under the predetermined condition.

### BRIEF DESCRIPTION OF THE DRAWINGS

Exemplary embodiments of the present disclosure will be described in detail based on the following figures, wherein:

FIG. 1 is a diagram illustrating a schematic configuration of a notification system;

FIG. 2 is a block diagram illustrating a hardware configuration of an information processing apparatus;

FIG. 3 is a block diagram illustrating a configuration of a storing unit;

FIG. 4 is a block diagram illustrating a hardware configuration of a user terminal;

FIG. 5 is a flowchart illustrating a flow of a process for generating an initial answer to a question item using an artificial intelligence (AI) and outputting a notification regarding the generated initial answer;

FIG. 6 illustrates a first example of answer histories stored in an answer history storing part;

FIG. 7 is a flowchart illustrating a flow of a process for generating an Nth-time answer to a question item using an AI and determining whether or not to output a notification regarding the generated Nth-time answer;

FIG. 8 illustrates a first display example of an input screen of a user terminal for inputting input information;

FIG. 9 illustrates a second display example of an input screen of a user terminal for inputting input information;

FIG. 10 is a flowchart illustrating a flow of a process for generating an Nth-time answer to a question item using an AI and determining whether or not to output a notification regarding the generated Nth-time answer;

FIG. 11 illustrates a second example of answer histories stored in the answer history storing part;

FIG. 12 is a flowchart illustrating a flow of a notification process;

FIG. 13 illustrates an example of a display on the user terminal indicating a fact that a change has occurred;

FIG. 14 illustrates an example of a display on the user terminal indicating the content of an answer and a factor affecting a change;

FIG. 15 illustrates an example of a display on the user terminal indicating a survey;

FIG. 16 is a flowchart illustrating a flow of a process performed after a notification regarding an answer generated using an AI to a question item is output;

FIG. 17 illustrates another example of a display on the user terminal indicating a fact that a change has occurred;

and

FIG. 18 illustrates a display example of a reminder screen displayed on the user terminal.

### DETAILED DESCRIPTION

Hereinafter, a notification system according to an exemplary embodiment will be described.

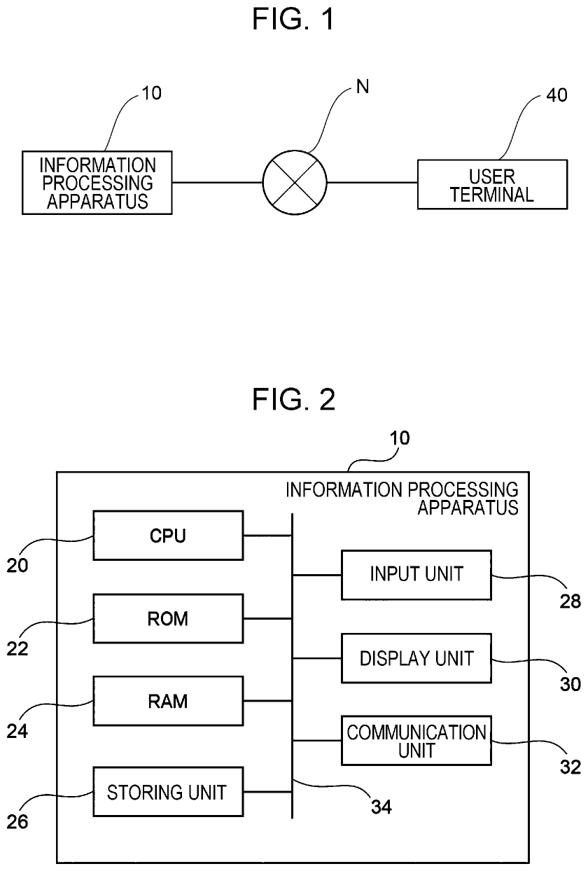

FIG. 1 is a diagram illustrating a schematic configuration of a notification system according to an exemplary embodiment.

As illustrated in FIG. 1, the notification system includes an information processing apparatus 10 and a user terminal 40. The information processing apparatus 10 and the user terminal 40 are connected via a network N. The network N may be, for example, the Internet, a local area network (LAN), or a wide area network (WAN).

The information processing apparatus 10 generates an answer to a question item using an artificial intelligence (AI) and outputs a notification regarding the generated answer to the user terminal 40. AIs may be categorized into various types. For example, there are so-called “general-purpose AIs” that are capable of handling every event and so-called “specialized AIs” that display their capabilities only for specific purposes. For example, an AI performs analysis to determine an answer to a question item. Methods for such analysis include machine learning, deep learning, and the like. Details of the information processing apparatus 10 will be described later.

The user terminal 40 provides a notification output from the information processing apparatus 10. Details of the user terminal 40 will be described later.

FIG. 2 is a block diagram illustrating a hardware configuration of the information processing apparatus 10. The information processing apparatus 10 may be, for example, a general-purpose computer apparatus such as a server computer or a personal computer (PC).

As illustrated in FIG. 2, the information processing apparatus 10 includes a central processing unit (CPU) 20, a read only memory (ROM) 22, a random access memory (RAM) 24, a storing unit 26, an input unit 28, a display unit 30, and a communication unit 32. The CPU 20, the ROM 22, the RAM 24, the storing unit 26, the input unit 28, the display unit 30, and the communication unit 32 are connected to one another so that they are able to communicate with one another via a bus 34. The CPU 20 is an example of a processor.

The CPU 20 executes various programs and controls the units of the information processing apparatus 10. That is, the CPU 20 reads a program from the ROM 22 or the storing unit 26 and executes the program using the RAM 24 as an operation region. The CPU 20 controls the units of the information processing apparatus 10 and performs various arithmetic processes in accordance with the program stored in the ROM 22 or the storing unit 26.

Various programs and various data are stored in the ROM 22. A program or data is temporarily stored in the RAM 24 as an operation region.

The storing unit 26 is a storage device such as a hard disk drive (HDD), a solid state drive (SSD), or a flash memory. Various programs including an operating system and various data are stored in the storing unit 26.

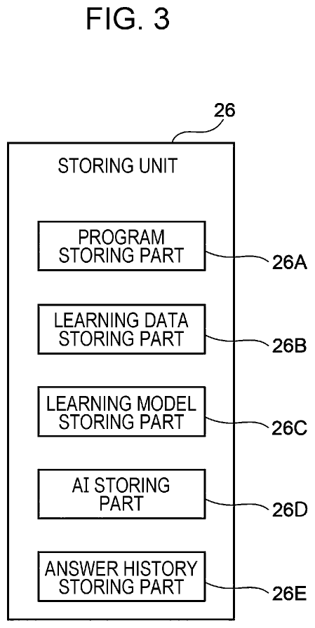

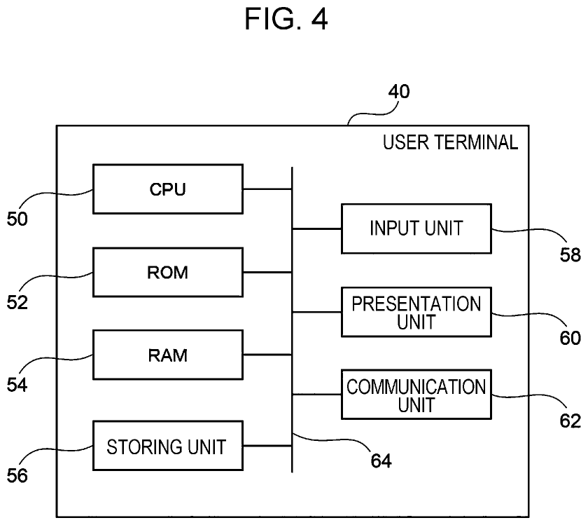

Furthermore, as illustrated in FIG. 3, the storing unit 26 includes a program storing part 26A, a learning data storing part 26B, a learning model storing part 26C, an AI storing part 26D, and an answer history storing part 26E.

An information processing program for outputting a notification regarding an answer to a question item is stored in the program storing part 26A. The information processing program may be installed in advance in the information processing apparatus 10 or may be installed in the information processing apparatus 10 in an appropriate manner by being stored in a non-volatile storage medium or being distributed via the network N. The non-volatile storage medium may be, for example, a compact disc-read only memory (CD-ROM), a magneto-optical disc, an HDD, a digital versatile disc-read only memory (DVD-ROM), a flash memory, or a memory card.

For example, various learning data that the CPU 20 has acquired via the network N are stored in the learning data storing part 26B. The learning data are used to generate a learning model by being provided as teacher data to a model or to update an already generated learning model.

Various learning models that have been learned based on learning data stored in the learning data storing part 26B are stored in the learning model storing part 26C. In an exemplary embodiment, types of learning models that may be used are not particularly limited. The learning models include, for example, a neural network model, a convolutional neural network model, a logistic regression model, and the like. Furthermore, in an exemplary embodiment, learning algorithms used for generating learning models are not particularly limited. The learning algorithms include, for example, random forest, support vector machine, logistic regression, deep learning, and the like.

Various AIs established in advance based on learning models stored in the learning model storing part 26C are stored in the AI storing part 26D. In an exemplary embodiment, an answer to a question item is generated using an AI read from the AI storing part 26D by the CPU 20. That is, in an exemplary embodiment, a so-called “AI chatbot” is established.

Answer histories, which are answers to question items generated using AIs, are stored in the answer history storing part 26E.

Referring back to FIG. 2, the input unit 28 includes a pointing device such as a mouse and a keyboard. The input unit 28 is used to perform various inputs.

The display unit 30 is, for example, a liquid crystal display. The display unit 30 displays various types of information. The display unit 30 may be of a touch panel type and function as the input unit 28.

The communication unit 32 is an interface for communicating with other apparatuses such as the user terminal 40. Such communication is based on, for example, standards for wired communication such as Ethernet® or fiber distributed data interface (FDDI) or standards for wireless communication such as 4G, 5G, or Wi-Fi®.

In execution of the information processing program mentioned above, the information processing apparatus 10 performs a process based on the information processing program using the hardware resources mentioned above.

FIG. 4 is a block diagram illustrating a hardware configuration of the user terminal 40. The user terminal 40 may be, for example, a general-purpose computer apparatus such as a server computer or a PC or a portable terminal such as a smartphone or a tablet terminal. The user terminal 40 may be a bearable terminal of an earphone type that inputs and outputs sound. The user terminal 40 may be used in conjunction with various wearable terminals of a watch type, a glasses type, a wristband type, a clip type, a head mount display type, or a strap type or such a wearable terminal may be used as the user terminal 40.

As illustrated in FIG. 4, the user terminal 40 includes a CPU 50, a ROM 52, a RAM 54, a storing unit 56, an input unit 58, a presentation unit 60, and a communication unit 62. The CPU 50, the ROM 52, the RAM 54, the storing unit 56, the input unit 58, the presentation unit 60, and the communication unit 62 are connected to one another so that they are able to communicate with one another via a bus 64.

The CPU 50 executes various programs and controls the units of the user terminal 40. That is, the CPU 50 reads a program from the ROM 52 or the storing unit 56 and executes the program using the RAM 54 as an operation region. The CPU 50 controls the units of the user terminal 40 and performs various arithmetic processes in accordance with the program stored in the ROM 52 or the storing unit 56.

Various programs and various data are stored in the ROM 52. A program or data is temporarily stored in the RAM 54 as an operation region. The storing unit 56 is a storage device such as an HDD, an SSD, or a flash memory. Various programs including an operating system and various data are stored in the storing unit 56.

The input unit 58 includes, for example, a pointing device such as a mouse, various buttons, a keyboard, a microphone, and a camera. The input unit 58 is used to perform various inputs.

The presentation unit 60 includes a display device, a vibration generation device, and a sound output device. The presentation unit 60 provides various types of information in the form of at least one of display, vibrations, and sound. The display device forming the presentation unit 60 is of a touch panel type and also functions as the input unit 58.

The communication unit 62 is an interface for communicating with other apparatuses such as the information processing apparatus 10. Such communication is based on, for example, standards for wired communication such as Ethernet or FDDI or standards for wireless communication such as 4G, 5G, or Wi-Fi.

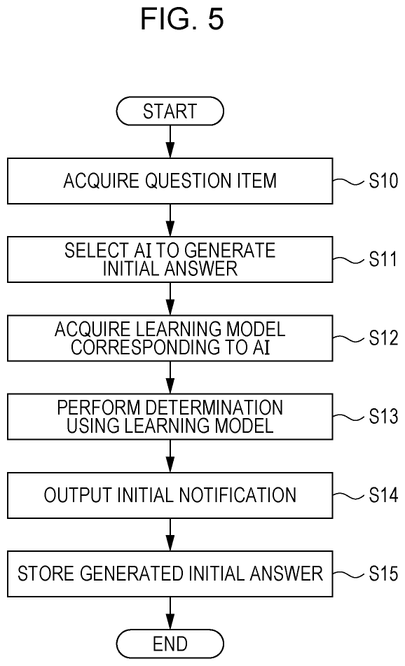

FIG. 5 is a flowchart illustrating a flow of a process performed by the information processing apparatus 10 for generating an initial answer, which is the first-time answer, to a question item using an AI and outputting a notification regarding the generated initial answer (hereinafter, referred to as an “initial notification”). The process is performed when the CPU 20 reads the information processing program from the program storing part 26A, loads the read information processing program onto the RAM 24, and executes the information processing program.

In step S10 in FIG. 5, the CPU 20 acquires from the user terminal 40 a question item input to the user terminal 40 by a user. Then, the process proceeds to step S11.

In step S11, the CPU 20 selects an AI to generate an initial answer from the AI storing part 26D. Then, the process proceeds to step S12. For example, it is assumed that the CPU 20 selects an AI from the AI storing part 26D by randomly selecting an AI, selecting a suitable AI in accordance with the question item input by the user, or selecting an AI corresponding to a setting performed by the user.

In step S12, the CPU 20 acquires from the learning model storing part 26C a learning model corresponding to the AI selected in step S11. Then, the process proceeds to step S13.

In step S13, the CPU 20 performs determination using the learning model acquired in step S12. That is, in this exemplary embodiment, when the question item from the user is input to the learning model acquired in step S12, the initial answer to the question item is generated. Then, the process proceeds to step S14.

In step S14, the CPU 20 outputs an initial notification including the generated initial answer to the user terminal 40. Then, the process proceeds to step S15.

In step S15, the CPU 20 stores an answer history of the generated initial answer into the answer history storing part 26E. Then, the process ends.

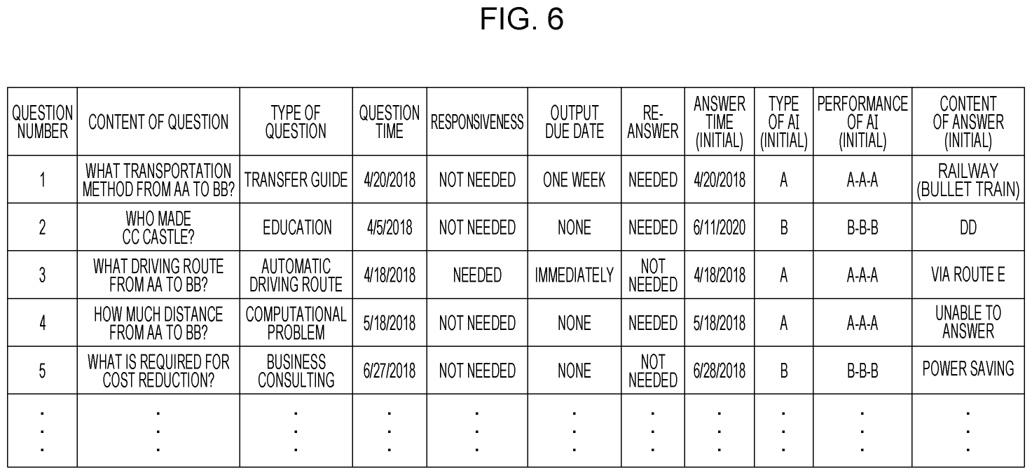

FIG. 6 illustrates a first example of answer histories stored in the answer history storing part 26E. In FIG. 6, items including question number, content of question, type of question, question time, responsiveness, output due date, re-answer, answer time (initial), type of AI (initial), performance of AI (initial), and content of answer (initial) are illustrated as answer histories, and information corresponding to the items is input.

A number for identifying a question item from a user is stored in the item “question number”. Hereinafter, for example, a question item with a “question number” of “1” will be referred to as “question 1”, and a question item with a “question number” of “2” will be referred to as “question 2”.

The content of a question item input by a user is stored in the item “content of question”. For example, in FIG. 6, “What transportation method from AA to BB?” is indicated as the content of the question 1.

The type of a question item input by a user is stored in the item “type of question”. In this exemplary embodiment, a plurality of types of question items are provided (for example, “transfer guide”, “education”, and so on). A type of question corresponding to a question item from a user that is specified by the CPU 20 from among the plurality of types of question items is stored in the item “type of question”.

The time when a question item was received from a user is stored in the item “question time”.

Information as to whether or not responsiveness is to be required for an answer to a question item input by a user is stored in the item “responsiveness”. The information obtained by the determination by the CPU 20 in accordance with the question item from the user is stored in the item “responsiveness”.

A due date by which a notification regarding an answer to a question item input by a user is expected to be output to the user terminal 40 is stored in the item “output due date”. An output due date specified by a user may be stored in the item “output due date”. Alternatively, the CPU 20 may specify an output due date based on a question item input by the user and the specified output due date may be stored in the item “output due date”.

Information as to whether or not a notification regarding re-answer to a question item input by a user needs to be output is stored in the item “re-answer”. In accordance with a setting performed by a user, “needed” or “not needed” may be input to the item “re-answer”. Alternatively, the CPU 20 may determine whether output of the notification regarding re-answer is “needed” or “not needed” in accordance with the question item input by the user and information based on the determination may be input to the item “re-answer”. In this exemplary embodiment, as described above, the CPU 20 receives a setting regarding whether or not to output the notification regarding re-answer to the question item. However, even in the case where a received setting indicates that such notification does not need to be output, the content of the re-answer to the question item generated using an AI is stored in the item “content of answer”.

The time when a notification regarding an answer to a question item input by a user was output to the user terminal 40 is stored in the item “answer time”. In FIG. 6, the time when an initial notification was output to the user terminal 40 is indicated.

The type of an AI used to generate an answer to a question item input by a user is stored in the item “type of AI”. In FIG. 6, the type of an AI used to generate an initial answer is indicated.

Performance of an AI that has generated an answer to a question item input by a user is stored in the item “performance of AI”. The term “performance of AI” represents a concept including a “learning model of AI”, “learning data used for AI”, and a “learning algorithm for AI”. In FIG. 6, for example, “A-A-A” described as the performance of the AI for the question 1 indicates that the AI that has generated the answer is established based on a learning model A (for example, a neural network model) generated based on a learning algorithm A (for example, deep learning) from a provided data group called learning data A. In FIG. 6, the performance of an AI that has generated an initial answer is indicated. The learning algorithm is an example of an “algorithm”.

The content of an answer to a question item input by a user is stored in the item “content of answer”. In FIG. 6, the content of an initial answer is indicated. In FIG. 6, for example, “train (bullet train)” is indicated as the content of an answer to the question 1.

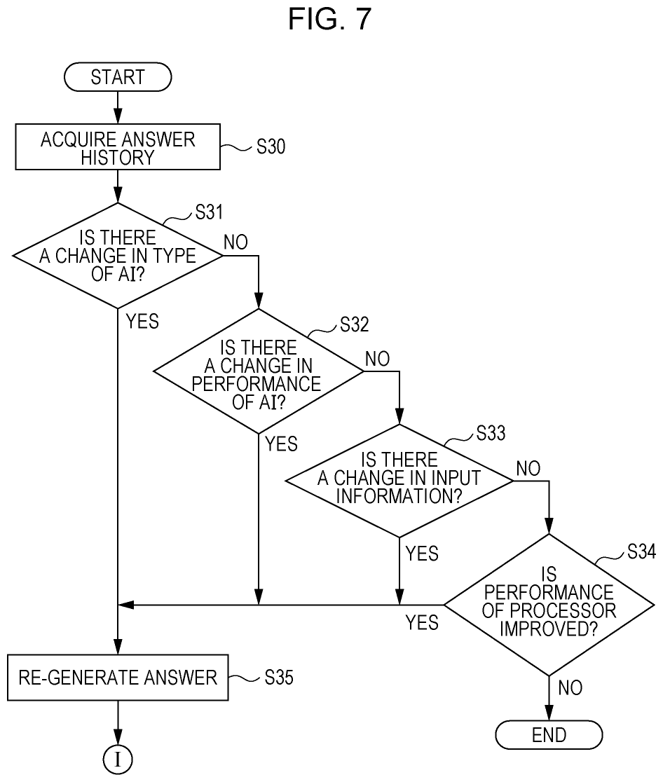

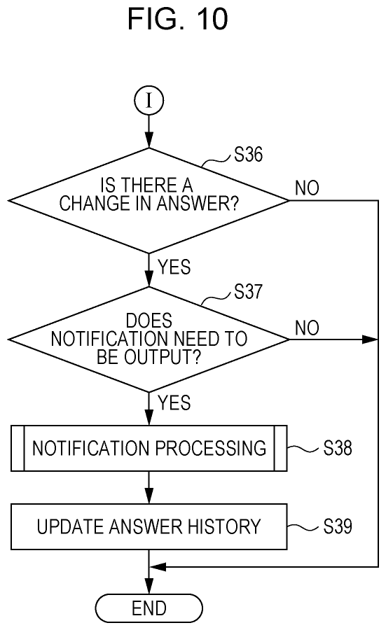

FIGS. 7 and 10 are flowcharts each illustrating a flow of a process performed by the information processing apparatus 10 for generating an Nth-time answer (N is a natural number of 2 or more) to a question item using an AI and determining whether or not to output a notification regarding the generated Nth-time answer (hereinafter, referred to as an “Nth-time notification”). The process is performed when the CPU 20 reads the information processing program from the program storing part 26A, loads the information processing program onto the RAM 24, and executes the information processing program. Hereinafter, for example, a case where N represents “2”, an Nth-time answer represents the “second-time answer”, and an Nth-time notification represents the “second-time notification” will be described.

In this exemplary embodiment, every time that a predetermined time has passed, a process for determining whether or not to output the Nth-time notification is performed. For example, in the case where the predetermined time is set to “24 hours”, a process for determining whether or not to output the second-time notification as the Nth-time notification is performed twenty-four hours after the process for outputting the initial notification illustrated in FIG. 5 is performed. Furthermore, in the case mentioned above, a process for determining whether or not to output the third-time notification as the Nth-time notification is performed twenty-four hours after the process for determining whether or not to output the second-time notification is performed.

In step S30 in FIG. 7, the CPU 20 acquires an answer history from the answer history storing part 26E. Then, the process proceeds to step S31. An answer history for a question item may be acquired or answer histories for a plurality of question items may be acquired in step S30. Furthermore, a partial answer history (for example, for the last three times) for a question item or the entire answer history for the question item may be acquired in step S30.

In step S31, the CPU 20 determines whether or not there has been a change in the type of an AI since generation of an answer, specifically, an initial answer, to the question item included in the answer history acquired in step S30. In the case where the CPU 20 determines that there has been a change in the type of an AI (step S31: Yes), the process proceeds to step S35. In contrast, in the case where the CPU 20 determines that there has been no change in the type of an AI (step S31: No), the process proceeds to step S32. In this exemplary embodiment, a method for changing the type of an AI is not particularly limited. For example, the type of an AI may be changed in accordance with a setting performed by a user or may be changed by the CPU 20 when a predetermined time has passed or when a predetermined number of answers have been generated.

In step S32, the CPU 20 determines whether or not there has been a change in the performance of the AI since the generation of the initial answer. In the case where the CPU 20 determines that there has been a change in the performance of the AI (step S32: Yes), the process proceeds to step S35. In contrast, in the case where the CPU 20 determines that there has been no change in the performance of the AI (step S32: No), the process proceeds to step S33.

In this exemplary embodiment, in the case where there has been a change in at least one of “learning model of AI”, “learning data used for AI”, and “learning algorithm for AI” as the performance of the AI, the CPU 20 determines that there has been a change in the performance of the AI.

Changes in the learning model of an AI include a change of the learning model itself from learning model A (for example, a neural network model) to learning model B (for example, a logistic regression model) and update of the learning model from learning model A1 (for example, a neural network model) to learning model A2 (for example, a neural network model).

For example, a change in the learning model of an AI may occur when the learning model itself is changed in accordance with input by a user or the CPU 20, when the learning model is updated by addition of learning data based on input by the user or the CPU 20, or the like. Furthermore, a change in learning data used for an AI may occur when a predetermined amount of data is provided as teacher data to a learning model. Moreover, a change in the learning algorithm for an AI may occur when the learning algorithm itself is changed (for example, change from deep learning to logistic regression) in accordance with input by the user or the CPU 20.

In step S33, the CPU 20 determines whether or not there has been a change in input information for the AI input by the user since the generation of the initial answer. In the case where the CPU 20 determines that there has been a change in the input information (step S33: Yes), the process proceeds to step S35. In contrast, in the case where the CPU 20 determines that there has been no change in the input information (step S33: No), the process proceeds to step S34.

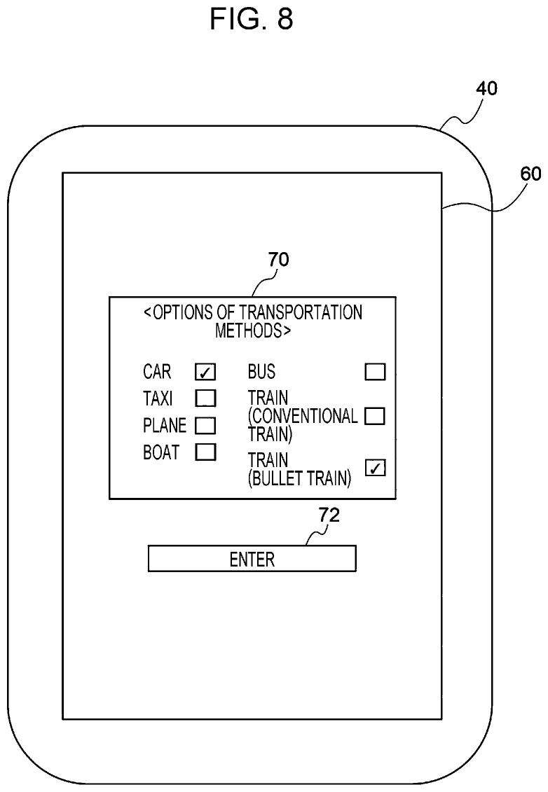

FIG. 8 illustrates a first display example of an input screen of the user terminal 40 for inputting input information. As illustrated in FIG. 8, an option display 70 indicating options of transportation methods to be selected as input information and an enter button 72 are displayed on the presentation unit 60. In this exemplary embodiment, when a user selects a desired transportation method out of the plurality of options of transportation methods indicated in the option display 70 and then operates the enter button 72, input information is transmitted to the information processing apparatus 10. In FIG. 8, a state in which “car” and “train (bullet train)” are selected as desired transportation methods out of the plurality of options of transportation methods indicated in the option display 70 is illustrated.

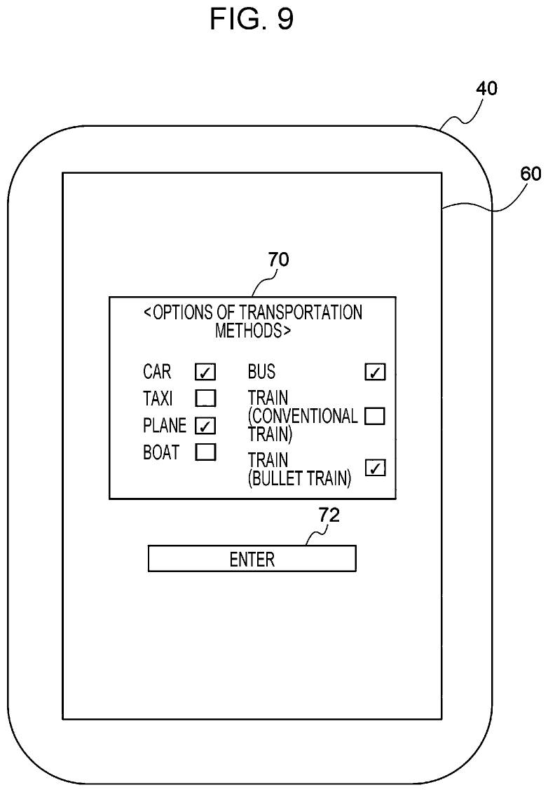

FIG. 9 illustrates a second display example of an input screen of the user terminal 40 for inputting input information. In FIG. 9, a state in which “car”, “bus”, “plane”, and “train (bullet train)” are selected as desired transportation methods out of the plurality of options of transportation methods indicated in the option display 70 is illustrated. That is, in FIG. 9, the number of transportation methods desired by the user is larger than that illustrated in FIG. 8. Processing based on the display examples illustrated in FIGS. 8 and 9 is performed at the user terminal 40 before the processing of step S33. That is, the determination in step S33 is performed on the basis of input information transmitted from the user terminal 40.

In the case where the number of transportation methods desired by the user has increased as described above, the CPU 20 determines in step S33 in FIG. 7 that there has been a change in the input information. In a similar manner, in the case where the number of transportation methods desired by the user has decreased, the CPU 20 determines in step S33 that there has been a change in the input information.

Referring back to FIG. 7, in step S34, the CPU 20 determines whether or not there has been an improvement in the performance of the processor since the generation of the initial answer. In the case where the CPU 20 determines that there has been an improvement in the performance (step S34: Yes), the process proceeds to step S35. In contrast, in the case where the CPU 20 determines that there has been no improvement in the performance (step S34: No), the process ends. For example, in the case where a graphics processing unit (GPU) is added to the information processing apparatus 10, the CPU 20 determines that there has been an improvement in the performance of the processor because an increase in the learning speed may be expected. The details of the processor will be described later. In the case where the information processing apparatus 10 includes only the CPU 20, the CPU 20 corresponds to the processor. In the case where the CPU 20 includes both the CPU 20 and a GPU, both the CPU 20 and the GPU correspond to the processor.

In step S35, the CPU 20 re-generates an answer, specifically, a second-time answer, to the question item included in the answer history acquired in step S30. Then, the process proceeds to step S36 illustrated in FIG. 10. In this exemplary embodiment, in a case where there has been a change in the learning model of the AI, as the performance of the AI, in step S32, the question item is input to the changed learning model, so that the second-time answer to the question item is generated. In the case where there has been no change in the learning model of the AI in step S32, the question item is input to the learning model that has generated the initial answer, so that the second-time answer to the question item is generated.

In step S36 in FIG. 10, the CPU 20 determines whether or not the second-time answer is different from the immediately previous answer notified to the user, that is, the initial answer. In the case where the CPU 20 determines that the second-time answer is different from the initial answer (step S36: Yes), the process proceeds to step S37. In contrast, in the case where the CPU 20 determines that the second-time answer is not different from the initial answer (step S36: No), the process ends.

In this exemplary embodiment, for example, it is assumed that the second-time answer is different from the initial answer when an event described below occurs.

(1) A case where, at the time of generation of the second-time answer, learning data regarding a change in the fact or a historical finding that is different from the fact proved at the time when the initial answer was generated is added.

(2) A case where, at the time of generation of the second-time answer, due to improvement in the performance of the processor compared to the time of generation of the initial answer, calculation may be performed faster than the case where the initial answer was generated.

(3) A case where, at the time of generation of the second-time answer, due to addition of learning data or improvement in the performance of the processor compared to the time of generation of the initial answer, a detailed answer may be generated (for example, content of question: “Which area of Japan has a large population?”, initial answer: “Tokyo”, second-time answer: “Shinjuku-ku”).

In step S37, the CPU 20 determines whether or not the second-time notification needs to be output. In the case where the CPU 20 determines that the second-time notification needs to be output (step S37: Yes), the process proceeds to step S38. In contrast, in the case where the CPU 20 determines that the second-time notification does not need to be output (step S37: No), the process ends.

In this exemplary embodiment, the user is able to set whether or not an Nth-time notification needs to be output. A determination result corresponding to the content of setting input to the user terminal 40 by the user is derived by the CPU 20. Furthermore, in this exemplary embodiment, in the case where the degree of difference between the immediately previous answer notified to the user (for example, initial answer) and the answer generated in step S35 (for example, second-time answer) is less than a predetermined reference value, the CPU 20 determines that the second-time notification does not need to be output. For example, a predetermined reference value for question 4 “How much distance from AA to BB?” (see FIG. 6) is set to “10 km”. In the case where the content of answer changes from “100 km” to “50 km”, the CPU 20 determines that the second-time notification needs to be output. In the case where the content of answer changes from “100 km” to “95 km”, the CPU 20 determines that the second-time notification does not need to be output.

In step S38, the CPU 20 performs notification processing. Then, the process proceeds to step S39. The details of the notification processing will be described later.

In step S39, the CPU 20 updates the answer history stored in the answer history storing part 26E. Then, the process ends.

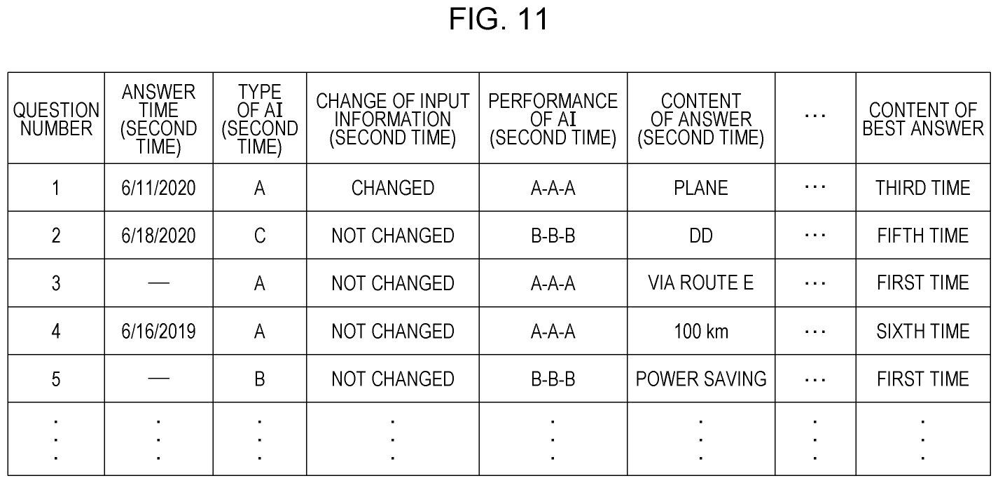

FIG. 11 illustrates a second display example of answer histories stored in the answer history storing part 26E. In FIG. 11, items including question number, answer time (second time), type of AI (second time), change of input information (second time), performance of AI (second time), content of answer (second time), and content of best answer are illustrated as answer histories, and information corresponding to the items is input.

Information as to whether or not there has been a change of the input information for the AI from the user is stored as the item “change of input information”. In FIG. 11, information regarding whether or not there is a change of input information when the second answer is generated using the AI is indicated.

The timing at which the answer determined to be the best answer among a plurality of answers to the question item generated using the AI was generated is stored in the item “content of best answer”. Selection of the best answer may be performed on the basis of input by the user or may be performed on the basis of a result of determination performed using the AI. For example, a plurality of types of AIs may generate answers to a single question item, and the most common answers among the generated answers may be determined to be the best answer.

The content of answer to the question 1 and the content of answer to the question 4 are changed between the initial answer and the second answer (see FIGS. 6 and 11). In contrast, the content of answer to the question 2, the content of answer to the question 3, and the content of answer to the question 5 are not changed between the initial answer and the second answer (see FIGS. 6 and 11). Regarding the question 3 and the question 5, the item “re-answer” illustrated in FIG. 6 indicates “not needed”, which represents that the second-time notification does not need to be output. Thus, in FIG. 11, the item “answer time (second time)” indicates “-”.

For example, it is assumed that the change in the content of the answer to the question 1 is derived from a change in input information. This is because the items “type of AI” and “performance of AI” are not changed between the initial answer and the second answer whereas the item “change of input information” indicates “changed” in FIG. 11.

It is assumed that the change in the content of the answer to the question 4 is derived from an improvement in the performance of the processor. This is because the items “type of AI” and “performance of AI” are not changed between the initial answer and the second answer and the item “change of input information” indicates “not changed” in FIG. 11.

In contrast, regarding the question 2, there is a change in the item “type of AI” between the initial answer and the second answer, whereas there is no change in the content of answer. In other words, the same result is generated as the content of answers to the question 2 by a plurality of types of AIs.

Furthermore, regarding the question 3 and the question 5, there are no changes in the items “type of AI” and “performance of AI” between the initial answer and the second answer, and the item “change of input information” indicates “not changed” in FIG. 11. Thus, it is assumed that there have been no change in the content of answer.

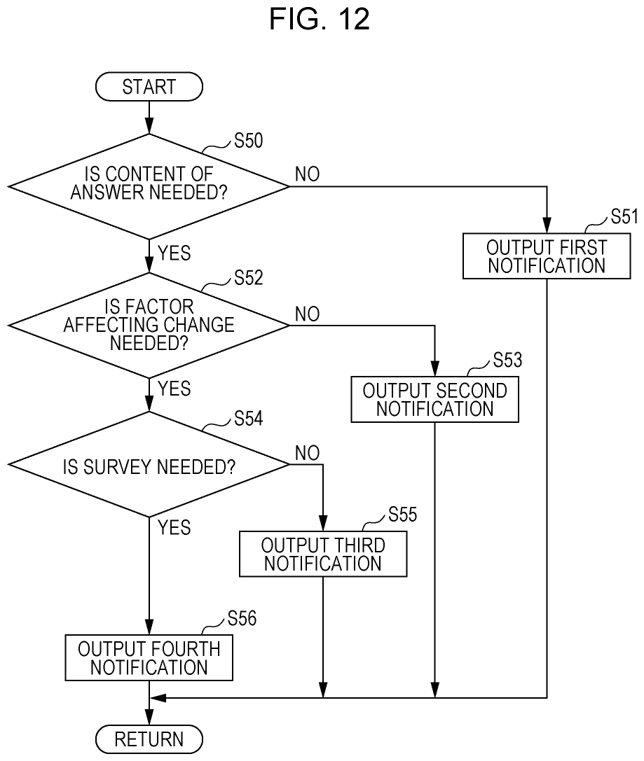

FIG. 12 is a flowchart illustrating a flow of a notification process performed by the information processing apparatus 10.

In step S50 in FIG. 12, the CPU 20 determines whether or not the second-time notification needs to include the content of the second-time answer. In the case where the CPU 20 determines that the content of the second-time answer is needed (step S50: Yes), the process proceeds to step S52. In contrast, in the case where the CPU 20 determines that the content of the second-time answer is not needed (step S50: No), the process proceeds to step S51. In this exemplary embodiment, the user is able to set whether or not the content of the second-time answer is needed. The result of the determination corresponding to the content of setting input to the user terminal 40 by the user is derived by the CPU 20.

In step S51, the CPU 20 outputs a first notification as the second-time notification to the user terminal 40. Then, the process proceeds to step S39 in FIG. 10. The first notification is a notification indicating occurrence of a change between the initial answer and the second-time answer (hereinafter, referred to as a “fact that a change has occurred”).

In step S52, the CPU 20 determines whether or not the second-time notification needs to include a factor affecting the change from the initial answer to the second-time answer (hereinafter, referred to as a “factor affecting a change”). In the case where the CPU 20 determines that a factor affecting the change is needed (step S52: Yes), the process proceeds to step S54. In contrast, in the case where the CPU 20 determines that a factor affecting the change is not needed (step S52: No), the process proceeds to step S53. In this exemplary embodiment, the user is able to set whether or not the factor affecting the change is needed. The result of the determination corresponding to the content of setting input to the user terminal 40 by the user is derived by the CPU 20.

In step S53, the CPU 20 outputs a second notification as the second-time notification to the user terminal 40. Then, the process proceeds to step S39 in FIG. 10. The second notification is a notification including a factor affecting a change and content of an answer.

In step S54, the CPU 20 determines whether or not the second-time notification needs to include a survey regarding the second-time answer. In the case where the CPU 20 determines that a survey is needed (step S54: Yes), the process proceeds to step S56. In contrast, in the case where the CPU 20 determines that a survey is not needed (step S54: No), the process proceeds to step S55. In this exemplary embodiment, the user is able to set whether or not the survey is needed. The result of the determination corresponding to the content of setting input to the user terminal 40 by the user is derived by the CPU 20.

In step S55, the CPU 20 outputs a third notification as the second-time notification to the user terminal 40. Then, the process proceeds to step S39 in FIG. 10. The third notification is a notification including a fact that a change has occurred, the content of an answer, and a factor affecting a change.

In step S56, the CPU 20 outputs a fourth notification as the second-time notification to the user terminal 40. Then, the process proceeds to step S39 in FIG. 10. The fourth notification is a notification including a fact that a change has occurred, the content of an answer, a factor affecting a change, and a survey.

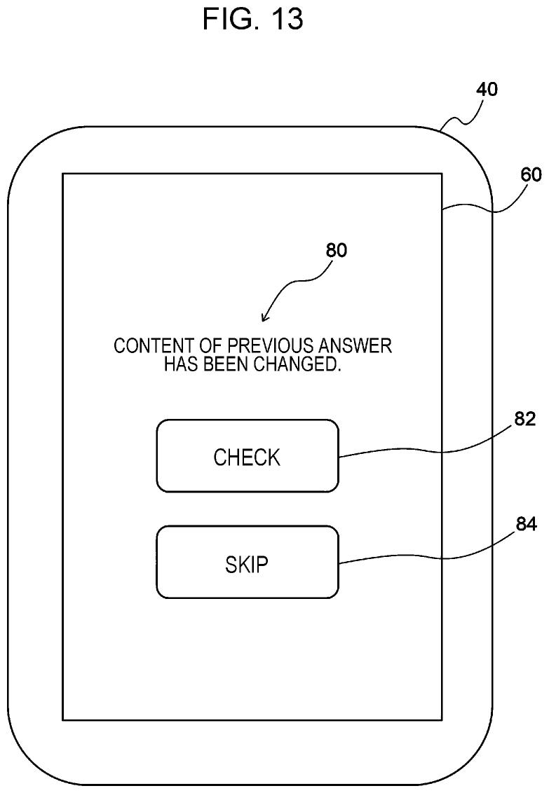

Display examples for a case where the fourth notification is output as the second-time notification to the user terminal 40 will be described below with reference to FIGS. 13 to 15.

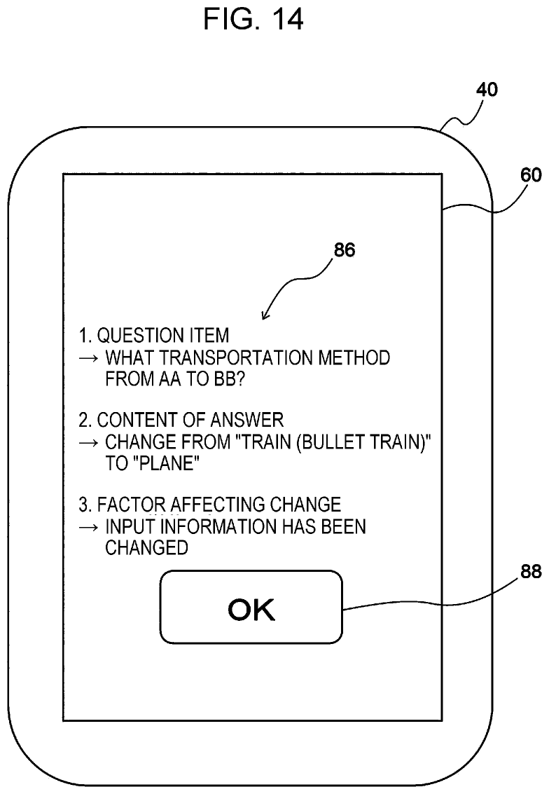

FIG. 13 illustrates a display example of a fact that a change has occurred displayed on the user terminal 40. As illustrated in FIG. 13, a message display 80, which describes a message for a user, as a fact that a change has occurred, a check button 82, and a skip button 84 are displayed on the presentation unit 60. The message display 80 in this display example indicates “Content of previous answer has been changed.”. In this exemplary embodiment, when a user operates the check button 82 while the display example is being displayed, the display example illustrated in FIG. 14 is displayed on the presentation unit 60. In contrast, when the user operates the skip button 84 while the display example is being displayed, the screen of the presentation unit 60 changes into predetermined content, and provision of the second-time notification output from the information processing apparatus 10 ends. In the case where the presentation unit 60 does not include a display device or in the case where the presentation unit 60 includes the display device but is set to provide the second-time notification using sound by a sound output device, the second-time notification may be provided by outputting sound. In this case, the second-time notification is provided in the form of a specific beep, voice guidance, or the like as sound by the sound output device. In a similar manner, in the case where the presentation unit 60 does not include the display device or the sound output device, the second-time notification may be provided in the form of vibrations with a predetermined vibration pattern produced by a vibration generation device. Obviously, the second-time notification may be provided to a user by a combination of a plurality of methods out of display, vibrations, and sound. In particular, in the case where a notification is provided only by vibrations, although a certain change may be notified, it is difficult to notify specific content of the change. Thus, it is desirable that at least one of display and sound may be used along with vibrations. Although an example of provision of the second-time notification in the form of display will be described below, the second-time notification may be provided using sound and/or vibrations as described above.

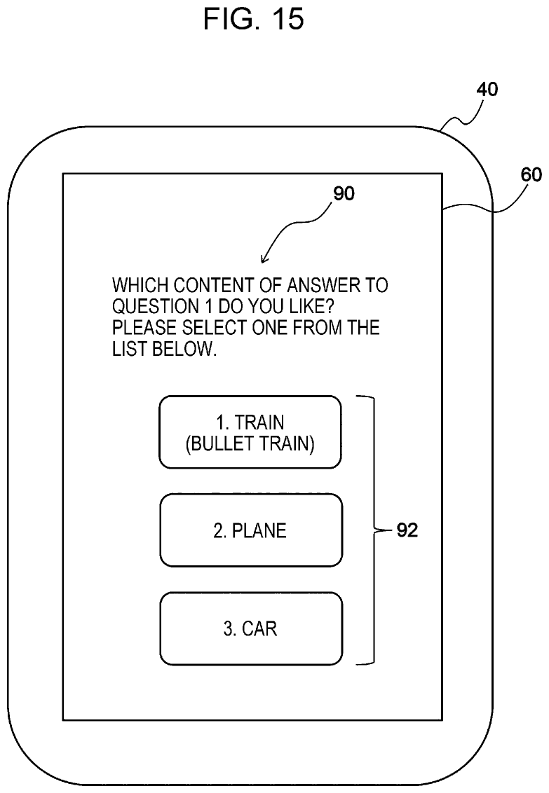

FIG. 14 illustrates a display example of content of an answer and a factor affecting a change displayed on the user terminal 40. As illustrated in FIG. 14, a message display 86, which describes messages for a user, as content of an answer and a factor affecting a change, and an OK button 88 are displayed on the presentation unit 60. The message display 86 in this display example indicates “1. Question item→What transportation method from AA to BB?”, 2. Content of answer→Change from “train (bullet train) to “plane”, and 3. factor affecting change→Input information has been changed”. In this exemplary embodiment, when the user operates the OK button 88 while the display example is being displayed, the display example illustrated in FIG. 15 is displayed on the presentation unit 60.

FIG. 15 illustrates a display example of a survey displayed on the user terminal 40. As illustrated in FIG. 15, a message display 90, which describes a message for a user, as a survey, and a plurality of selection buttons 92 are displayed on the presentation unit 60. The message display 90 in this display example indicates “Which content of answer to question 1 do you like? Please select one from the list below.”. In this exemplary embodiment, when the user operates one of the selection buttons 92 while the display example is being displayed, the screen of the presentation unit 60 changes to predetermined content, and provision of the second-time notification output from the information processing apparatus 10 ends. Furthermore, in this exemplary embodiment, when one of the selection buttons 92 is selected, content of the selected selection button 92 is transmitted to the information processing apparatus 10 as content of a response to the survey.

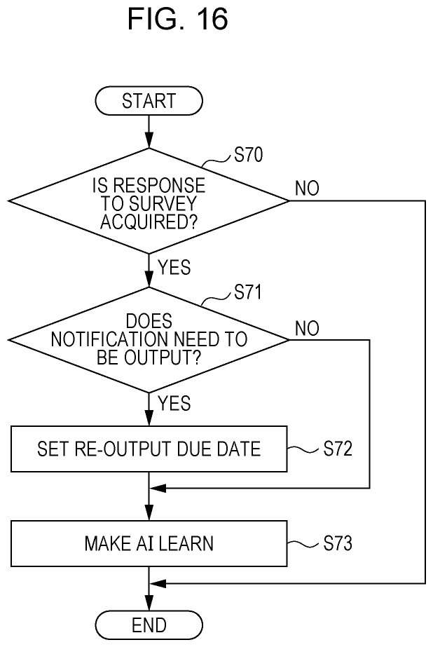

FIG. 16 is a flowchart illustrating a flow of a process performed by the information processing apparatus 10 after outputting an Nth-time notification. The process is performed when the CPU 20 reads the information processing program from the program storing part 26A, loads the read information processing program onto the RAM 24, and executes the information processing program. A case where, for example, N represents “2” and an Nth-time notification represents a “second-time notification” will be described below.

In step S70 in FIG. 16, the CPU 20 determines whether or not a response to a survey is acquired from a user. In the case where the CPU 20 determines that an answer is acquired (step S70: Yes), the process proceeds to step S71. In contrast, in the case where the CPU 20 determines that no answer is acquired (step S70: No), the process ends. For example, in the case where content of a response to a survey is transmitted from the information processing apparatus 10 in accordance with an operation on one of the selection buttons 92 illustrated in FIG. 15, the CPU 20 determines that an answer is acquired. In the case where the second-time notification does not include a survey regarding the second-time answer, the CPU 20 determines that no response is acquired.

In step S71, the CPU 20 determines whether or not a notification regarding an answer to the question item needs to be output. In the case where the CPU 20 determines that the notification regarding the answer to the question item needs to be output (step S71: Yes), the process proceeds to step S72. In contrast, in the case where the CPU 20 determines that the notification regarding the answer to the question item does not need to be output (step S71: No), the process proceeds to step S73. For example, in the case where “Needed” is input for the item “re-answer” of an answer history corresponding to the question item, the CPU 20 determines that the notification regarding the answer to the question item needs to be output. In contrast, in the case where “Not needed” is input, the CPU 20 determines that such notification does not need to be output. Even in the case where “Needed” is input for the item “re-answer”, if a response to the survey from the user includes information “notification is not needed”, the CPU 20 may update the item “re-answer” from “Needed” to “Not needed” and determine that such notification does not need to be output.

In step S72, the CPU 20 sets a re-output due date by which the notification regarding the answer to the question item is expected to be output. Then, the process proceeds to step S73. This re-output due date may be specified by the user or may be specified by the CPU 20 in accordance with the question item.

In S73, the CPU 20 makes the AI to learn. Then, the process ends. Specifically, the CPU 20 provides the acquired content of the response to the survey as learning data to the learning model that has generated the second-time answer, and thus makes the AI learn in accordance with the response to the survey from the user.

In the case where an answer to a question item is output using an AI, for example, when learning data is added or a learning model is changed, a new answer different from a previously output answer may be output. However, in the case where an answer to a question is obtained from the AI and a new answer to the question is then generated, it is difficult for a user to understand that the new answer has been generated.

Thus, in this exemplary embodiment, the CPU 20 outputs an initial answer to a question item using an AI. In the case where a predetermined condition is satisfied after the initial answer is output, the CPU 20 outputs a notification regarding an Nth-time answer (Nth-time notification), which is a new answer to the question item under the predetermined condition. Accordingly, in this exemplary embodiment, provision of the output Nth-time notification may allow a user to check the answer to the question item. Thus, according to this exemplary embodiment, in the case where an answer to a question is acquired using an AI and a new answer to the question is then generated, the user is able to understand that the new answer has been generated.

In this exemplary embodiment, the CPU 20 determines, based on the determination criteria described below, whether or not the “predetermined condition” is satisfied.

For example, in this exemplary embodiment, in the case where the type of an AI is changed, the CPU 20 determines that the predetermined condition is satisfied. Thus, according to this exemplary embodiment, a notification regarding an answer to a question item is output in accordance with a change of the type of an AI.

Furthermore, in this exemplary embodiment, in the case where a learning model of an AI is changed, the CPU 20 determines that the predetermined condition is satisfied. Thus, according to this exemplary embodiment, a notification regarding an answer to a question item is output in accordance with a change of a learning model of an AI.

Furthermore, in this exemplary embodiment, in the case where learning data for an AI is added, the CPU 20 determines that the predetermined condition is satisfied. Thus, according to this exemplary embodiment, a notification regarding an answer to a question item is output in accordance with addition of learning data for an AI.

Furthermore, in this exemplary embodiment, in the case where a learning algorithm for an AI is changed, the CPU 20 determines that the predetermined condition is satisfied. Thus, according to this exemplary embodiment, a notification regarding an answer to a question item is output in accordance with a change of a learning algorithm for an AI.

Furthermore, in this exemplary embodiment, in the case where performance of the processor is improved, the CPU 20 determines that the predetermined condition is satisfied. Thus, according to this exemplary embodiment, a notification regarding an answer to a question item is output in accordance with an improvement in the performance of the processor.

Furthermore, in this exemplary embodiment, in the case where input information for an AI input by the user is changed, the CPU 20 determines that the predetermined condition is satisfied. Thus, according to this exemplary embodiment, a notification regarding an answer to a question item is output in accordance with a change of input information for an AI.

Furthermore, in this exemplary embodiment, in the case where an Nth-time answer is different from the initial answer, the CPU 20 outputs an Nth-time notification. Thus, according to this exemplary embodiment, compared to a configuration in which a notification regarding an answer is output even if the answer using an AI has not been changed, the frequency of notification output may be regulated.

Furthermore, in this exemplary embodiment, even in the case where an Nth-time answer is different from the initial answer, if the degree of difference between the initial answer and the Nth-time answer is less than a predetermined reference value, the CPU 20 does not output a notification regarding the Nth-time answer. Thus, according to this exemplary embodiment, a determination as to whether or not to output a notification regarding an answer to a question item may be performed in accordance with the degree of difference between the initial answer and the Nth-time answer.

Nowadays, demands for explanation of the logic of determination using an AI as to, for example, whether or not to output an answer to a question item using the AI have been increased. However, in the case of known determination using an AI, the logic of such determination is black-boxed, and it is difficult to explain the logic of such determination.

Meanwhile, in this exemplary embodiment, an Nth-time notification includes a satisfied predetermined condition as described above. In addition, in this exemplary embodiment, the satisfied predetermined condition corresponds to a factor affecting a change, and the factor affecting the change is displayed on the user terminal 40, as illustrated in FIG. 14. Thus, according to this exemplary embodiment, the user is able to understand the satisfied predetermined condition. That, is, according to this exemplary embodiment, the logic of the determination that an Nth-time answer is different from a previous answer is white-boxed, and the logic of the determination is able to be explained.

Furthermore, in this exemplary embodiment, an Nth-time notification includes an Nth-time answer. Thus, in this exemplary embodiment, the Nth-time answer corresponds to content of an answer, and the content of the answer is displayed on the user terminal 40, as illustrated in FIG. 14. Thus, according to this exemplary embodiment, the user is able to understand the Nth-time answer.

Furthermore, in this exemplary embodiment, an Nth-time notification includes a survey regarding an answer to a question item. In this exemplary embodiment, the survey is displayed on the user terminal 40, as illustrated in FIG. 15. Thus, according to this exemplary embodiment, the user is able to understand the survey regarding the answer to the question item.

Furthermore, in this exemplary embodiment, the CPU 20 determines, according to the content of the acquired response to the survey, whether or not to output the Nth-time notification. Thus, according to this exemplary embodiment, compared to a configuration in which Nth-time notifications are continuously output, the frequency of notification output may be regulated.

Furthermore, in this exemplary embodiment, the CPU 20 makes an AI learn using the acquired content of the response to the survey. Accordingly, according to this exemplary embodiment, an AI suitable for characteristics of the user may be established. Thus, according to this exemplary embodiment, the AI that has learned may be able to generate answers to question items of the same type of question (for example, transfer guide (see FIG. 6)) that are suitable for characteristics of the user.

Furthermore, in this exemplary embodiment, the CPU 20 receives a setting for the output due date by which the Nth-time notification is expected to be output. For example, the CPU 20 receives a setting for the output due date input to the user terminal 40 by the user, and outputs the Nth-time notification to the user terminal 40 by the received output due date. Thus, according to this exemplary embodiment, compared to a configuration in which the Nth-time notification is able to be output indefinitely without any output due date being set, the frequency of notification output may be regulated.

Furthermore, in this exemplary embodiment, in the case where the CPU 20 receives a setting as to whether or not to output the Nth-time notification and the received setting is that the Nth-time notification does not need to be output, the CPU 20 stops outputting of the Nth-time notification but stores the generated Nth-time answer (see FIGS. 6 and 11). Thus, according to this exemplary embodiment, even if outputting of the Nth-time notification is stopped, the user is able to understand the Nth-time answer. For example, in this exemplary embodiment, even if outputting of the Nth-time notification is stopped, the user is able to access an answer history stored in the answer history storing part 26E at a desired timing to check the stored Nth-time answer.

### (Others)

In the exemplary embodiment described above, the initial answer is an example of a first answer, and the second-time answer is an example of a second answer. However, each of the first answer and the second answer is not limited to the example described above. For example, in the case where N represents “3” and an Nth-time answer represents a “third-time answer”, the initial answer or the second-time answer is an example of the first answer, and the third-time answer is an example of the second answer.

In the exemplary embodiment described above, the initial answer is an example of the first answer, the second-time answer is an example of the second answer, and a determination as to whether or not the second-time answer is different from the initial answer is performed in step S36 in FIG. 10. However, an answer for which a determination regarding a change is performed in step S36 is not necessarily the “immediately previous answer” that is obtained immediately before the new answer but may be any “previous answer”. For example, in the case where N represents “3” and the Nth-time answer represents the third-time answer, a determination as to where or not the third-time answer is different from at least one of the initial answer and the second-time answer may be performed in step S36.

In the exemplary embodiment described above, the information processing program is stored in the program storing part 26A. However, the information processing program is not necessarily stored in the program storing part 26A but may be stored in the ROM 22.

In the exemplary embodiment described above, an answer to a question item is generated using an AI. However, an answer to a question item is not necessarily generated using an AI. Answers may be generated using a plurality of AIs. In the case where the plurality of AIs generate different answers to a question item, a notification regarding the answers from all the AIs may be output or a notification regarding answer(s) from part of the plurality of AIs may be output. Furthermore, in the case where answers to a question item are generated using a plurality of AIs, only when the initial answer (an example of the first answer) and the second-time answer (an example of the second answer) generated by a specific AI are different, a notification regarding the answer generated by the specific AI may be output.

In the exemplary embodiment described above, the type of an AI that generates an answer to a question item is not particularly limited. For example, types of AIs include so-called “general-purpose AI”, “specialized AI”, “weak AI”, and “strong AI”. Furthermore, an AI may perform machine learning for acquiring knowledge or does not necessarily perform machine learning.

In the exemplary embodiment described above, in the case where an Nth-time answer is different from the initial answer, the CPU 20 outputs an Nth-time notification. However, the CPU 20 does not necessarily output the Nth-time notification in the case where the Nth-time answer is different from the initial answer. The CPU 20 may also output the Nth-time notification in the case where the Nth-time answer is the same as the initial answer. Accordingly, the user is able to understand that the content of the initial answer is the same as the content of the Nth-time answer. Thus, the reliability of an answer to a question item may be improved.

In the exemplary embodiment described above, a “predetermined reference value” of the degree of difference between the initial answer and the second-time answer is set to “10 km”. However, the predetermined reference value may be set appropriately in accordance with a question item input by the user. For example, for a question item “How much delay time to AA Station?”, the predetermined reference value may be set to “five minutes”. In this case, in the case where the content of an answer is changed from “10 minutes” to “20 minutes”, the CPU 20 determines that the second-time notification needs to be output in step S37 in FIG. 10. In contrast, in the case where the content of the answer is changed from “10 minutes” to “13 minutes”, the CPU 20 determines that the second-time notification does not need to be output in step S37. Furthermore, the predetermined reference value may be set for each question item or may be set for each type of question.

In the exemplary embodiment described above, every time that the predetermined time has passed, the determination as to whether or not to output an Nth-time notification is performed. However, the determination as to whether or not to output the Nth-time notification is not necessarily performed every time that the predetermined time has passed. The determination as to whether or not to output the Nth-time notification may be performed at a timing based on a determination performed by the CPU 20. For example, in the case where the CPU 20 determines that an answer generated by an AI may be changed due to addition of learning data, the determination as to whether or not to output the Nth-time notification may be performed.

In the exemplary embodiment, the CPU 20 receives a setting for an output due date by which an Nth-time notification is expected to output. However, the output due date is not necessarily provided.

In the exemplary embodiment described above, after an answer is generated in step S35 in FIG. 7, the notification processing in step S38 in FIG. 10 is performed. That is, in the exemplary embodiment described above, generation of an answer to a question item causes a notification regarding the answer to be output. However, a notification regarding an answer to a question item is not necessarily output after generation of the answer. The notification regarding the answer to the question item may be output before the answer is generated.

In the exemplary embodiment described above, a notification regarding an answer to a question item output from the information processing apparatus 10 is pop-up displayed on the presentation unit 60 of the user terminal 40. However, such a notification is not necessarily pop-up displayed. For example, the information processing apparatus 10 may transmit an electronic mail including an attached file to the user terminal 40, and the user terminal 40 may open the attached file, so that the notification may be displayed on the presentation unit 60.

In the exemplary embodiment described above, part of answer history stored in the answer history storing part 26E may be deleted in accordance with input by the user or the CPU 20. In this case, a notification regarding the deleted part of answer history (for example, an answer history of the second-time answer) will not be provided in the future.

In the exemplary embodiment described above, an Nth-time notification includes a satisfied predetermined condition, so that the user is able to understand the predetermined condition. However, the predetermined condition is not necessarily presented to the user. The Nth-time notification does not necessarily include the satisfied predetermined condition, and the user is not necessarily allowed to understand the predetermined condition.

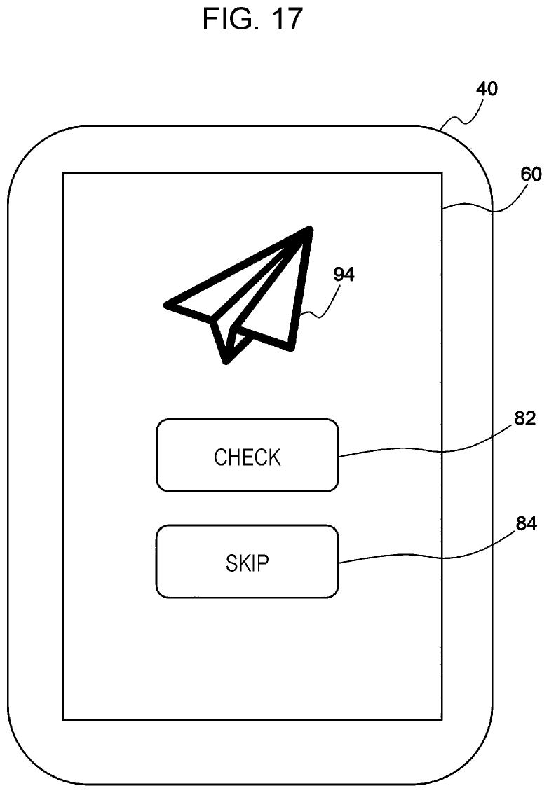

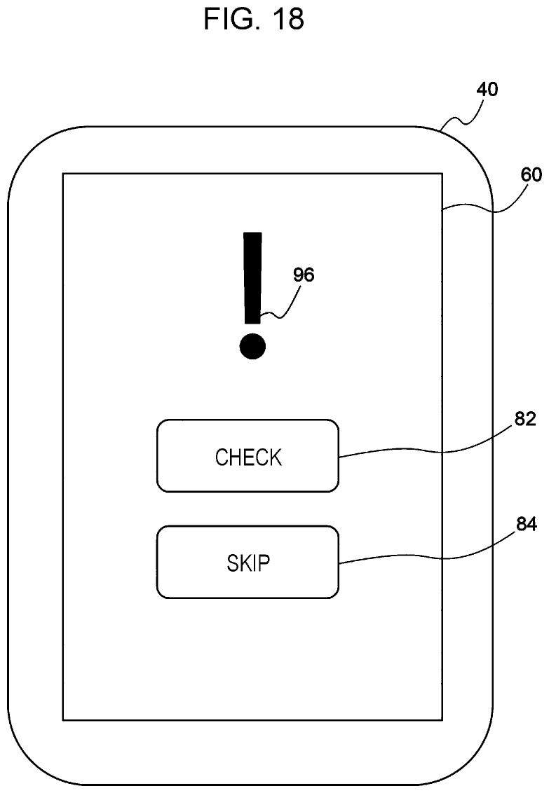

In the exemplary embodiment described above, the message display 80 indicating “Content of previous answer has been changed.” is displayed on the presentation unit 60, so that a fact that a change has occurred is notified (see FIG. 13). However, a fact that a change has occurred is not necessarily notified in the method described above. For example, as illustrated in FIG. 17, an icon 94 indicating a paper plane, the check button 82, and the skip button 84 may be displayed on the presentation unit 60, so that a fact that a change has occurred may be notified. Furthermore, in the exemplary embodiment described above, in the case where the check button 82 or the skip button 84 is not operated when a predetermined time has passed since display of a fact that a change has occurred illustrated in FIG. 13 or FIG. 17 on the presentation unit 60, an icon 96 indicating an exclamation mark illustrated in FIG. 18 may be displayed on the presentation unit 60. Accordingly, the display example illustrated in FIG. 18 transitions to a reminder screen prompting a user to operate the check button 82 or the skip button 84, and an operation on the check button 82 or the skip button 84 by the user will be expected.

In the exemplary embodiment described above, a so-called “AI chat bot” is established. The AI generates an answer to a question item input by a user and outputs a notification regarding the generated answer. However, an example of usage of an AI is not particularly limited. For example, an AI may be used for “advanced diagnosis of the health state or early indication of disease onset, using bio-information, lifestyle behaviors, medical history, genetic family history, or the like”, “advanced analysis of early indication of crime occurrence, using surveillance-camera video, information of a witnessing suspicious activity, or the like”, “optimization of a supply chain by demand prediction, production management, or the like”, “advanced detection of an unknown cyber-attack, unauthorized access by an internal crime or the like, or a financial crime such as illegal money transfer, or the like”, “advanced and automatic deletion of junk e-mail, based on user's preference, email history, an email source, or the like”, “yield maximization by advanced and automatic financial asset management, based on market's price movement or the like”, “avoidance of bad debt by calculating an optimal loan amount, based on the financial condition of a credit grant recipient”, “user retention and user satisfaction improvement by setting prices to meet demand, such as preferential treatment of best customers or provision of an impressive experience”, or the like.

In the exemplary embodiment described above, an example in which the CPU 20 determines in step S34 in FIG. 7 that performance of the processor is improved in the case where a GPU is added to the information processing apparatus 10 is described. However, the case where the CPU 20 determines that performance of the processor is improved in step S34 is not limited to the example described above. For example, in the case where a cooling fan is added to the information processing apparatus 10, improvement of cooling efficiency of the CPU 20 is expected. Thus, in step S34, the CPU 20 may determine that performance of the processor is improved.

Furthermore, an AI used in the exemplary embodiment described above may be of a type that will be produced in the future. For example, technical features described in an exemplary embodiment may be applied to any type of AI as long as an answer previously generated by the AI changes due to a change of a learning model, lapse of time, or the like.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to output a plurality of answers to a question item by using an artificial intelligence, wherein the processor is configured to:
output a first answer of the plurality of answers to the question item; and
output, in a case where a predetermined condition is satisfied after the first answer is output, a first notification regarding a second answer of the plurality of answers to the question item, the second answer being a new answer to the question item under the predetermined condition.

2. The information processing apparatus according to claim 1, wherein the processor is configured to output the first notification in a case where the second answer is different from the first answer.

3. The information processing apparatus according to claim 2, wherein the processor is configured, even in a case where the second answer is different from the first answer, when a degree of difference between the first answer and the second answer is less than a predetermined reference value, not to output the first notification.

4. The information processing apparatus according to claim 2, wherein the first notification includes the satisfied predetermined condition.

5. The information processing apparatus according to claim 3, wherein the first notification includes the satisfied predetermined condition.

6. The information processing apparatus according to claim 1, wherein the first notification includes the second answer.

7. The information processing apparatus according to claim 2, wherein the first notification includes the second answer.

8. The information processing apparatus according to claim 3, wherein the first notification includes the second answer.

9. The information processing apparatus according to claim 1, wherein the first notification includes a survey regarding one or more answers that have been output by the artificial intelligence to answer the question item.

10. The information processing apparatus according to claim 9, wherein the processor is configured to determine, in accordance with content of a response to the survey, whether or not to output a second notification regarding a third answer of the plurality of answers to the question item, the third answer being an answer to the question item that is newer than the second answer.

11. The information processing apparatus according to claim 9, wherein the processor is configured to make the artificial intelligence learn using content of a response to the survey.

12. The information processing apparatus according to claim 1, wherein the processor is configured to, in a case where a type of the artificial intelligence is changed, determine that the predetermined condition is satisfied.

13. The information processing apparatus according to claim 1, wherein the processor is configured to, in a case where a learning model of the artificial intelligence is changed, determine that the predetermined condition is satisfied.

14. The information processing apparatus according to claim 1, wherein the processor is configured to, in a case where learning data for the artificial intelligence is added, determine that the predetermined condition is satisfied.

15. The information processing apparatus according to claim 1, wherein the processor is configured to, in a case where an algorithm for the artificial intelligence is changed, determine that the predetermined condition is satisfied.

16. The information processing apparatus according to claim 1, wherein the processor is configured to, in a case where performance of the processor is improved, determine that the predetermined condition is satisfied.

17. The information processing apparatus according to claim 1, wherein the processor is configured to, in a case where input information for the artificial intelligence input by a user is changed, determine that the predetermined condition is satisfied.

18. The information processing apparatus according to claim 1, wherein the processor is configured to receive a setting for an output due date by which the first notification is expected to be output.

19. The information processing apparatus according to claim 1, wherein the processor is configured to:
receive a setting regarding whether or not to output the first notification; and
in a case where the received setting is that the first notification does not need to be output, stop outputting of the first notification but store the generated second answer.

20. A non-transitory computer readable medium storing a program causing a computer to execute a process for information processing, the process comprising outputting a plurality of answers to a question item by using an artificial intelligence,
wherein the process comprises:
outputting a first answer of the plurality of answers to the question item; and
outputting, in a case where a predetermined condition is satisfied after the first answer is output, a first notification regarding a second answer of the plurality of answers to the question item, the second answer being a new answer to the question item under the predetermined condition.
